(19) United States
(12) Patent Application Publication
(10) Pub. No.: US 2013/0234907 A1
(43) Pub. Date: Sep. 12, 2013

(54) WIRELESS TERMINAL WITH A PLURALITY OF ANTENNAS

(71) Applicant: PANTECH CO., LTD., Seoul (KR)

(72) Inventor: Kyoung-Sang YOO, Seoul (KR)

(73) Assignee: Pantech Co., Ltd., Seoul (KR)

(21) Appl. No.: 13/777,408

(22) Filed: Feb. 26, 2013

(30) Foreign Application Priority Data
Mar. 7, 2012 (KR) 10-2012-0023170

(51) Int. Cl. H01Q 1/50

(52) U.S. Cl. CPC H01Q 1/50
USPC 343/846

(57) ABSTRACT

A terminal includes a main ground including a first portion and a second portion; a primary antenna connected to the first portion of the main ground; a secondary antenna connected to the second portion of the main ground; and a first dummy ground disposed within a reference proximity to at least one of the primary antenna and the secondary antenna.

### CROSS-REFERENCE TO RELATED APPLICATION

This application claims priority from and the benefit under 35 U.S.C. §119(a) of Korean Patent Application No. 10-2012-0023170, filed on Mar. 7, 2012, the entire disclosure of which is incorporated herein by reference for all purposes.

### BACKGROUND

1. Field

The following description relates to a terminal with a plurality of antennas, in which dummy grounds, which selectively connect to a main ground, are disposed within a reference proximity to the individual antennas.

2. Discussion of the Background

Conventional mobile communication systems have utilized a single type antenna or a combination type antenna consisting of internal and external antennas. However, with introduction of smaller sized and/or slimmer mobile terminals, many more mobile terminal products are being designed and/or manufactured with only internal antennas. Further, in order to provide high-speed multimedia services based on wireless mobile communication technologies, an increase in communication capacity of a mobile communication system may be more accelerated. Studies into an antenna technology for providing a broadband mobile communication system, which may fabricate a smaller sized antenna, cover a large communication capacity, and increase reliability in communication, are actively being conducted.

In order to satisfy the above-mentioned conditions, an antenna technology based on Multi-Input Multi-Output (MIMO) or Diversity has been proposed.

A MIMO/Diversity antenna may improve reliability of data transmission, and may also overcome limitations in transmission amount of data for mobile communication, due at least in part, to the expansion of data communication, and the like. However, installing a MIMO/Diversity antenna in an interior space or cavity of a small-sized and/or slim-type mobile communication terminal may still have a problem related to deterioration in transmission/reception performance, which may be due, at least in part, to mutual coupling or insufficient isolation between individual antenna elements.

In order to overcome the problem, a method for increasing a distance between the individual antenna elements may be placed into consideration. However, it may be difficult to apply the method to a small-sized and/or slim-type antenna system, which may provide a limited space for antenna elements.

An antenna system may include a plate board type MIMO array antenna including an isolation element for preventing or reducing interference between antennas. However, the conventional technique has been simulated only with respect to a high frequency of 5 gigahertz (GHz), and requires, in a frequency band of approximately 900 megahertz (MHz), an antenna length of approximately 15 centimeters (cm), and a minimum length or width of (¼λ) to implement an antenna. Accordingly, it may be difficult to mount two 900 MHz antennas on a flat board of a general mobile terminal and position an isolation device between the two antennas.

Further, an antenna may include a band stop filter inserted into a feed portion or an end portion of the main radiator of each antenna in order to improve isolation characteristics. However, since this technique utilizes a lumped element as the band stop filter, the characteristic differences may be caused, at least in part, to the deviation between elements, and the band stop filter itself may deteriorate the characteristics of each antenna in a MIMO environment that uses the same frequency.

### SUMMARY

Exemplary embodiments of the present invention provide a terminal with a plurality of antennas, in which dummy grounds, which selectively connect to a main ground, are disposed within a reference proximity to the individual antennas.

Additional features of the invention will be set forth in the description which follows, and in part will be apparent from the description, or may be learned by practice of the invention.

Exemplary embodiments of the present invention provide a terminal including a main ground including a first portion and a second portion; a primary antenna connected to the first portion of the main ground; a secondary antenna connected to the second portion of the main ground; and a first dummy ground disposed within a reference proximity to at least one of the primary antenna and the secondary antenna.

Exemplary embodiments of the present invention provide a method for controlling dummy grounds in a terminal including turning on a switch of a first dummy ground connected to a primary antenna; determining whether a reference type communication can be performed; and turning on a switch of a second dummy ground connected to a secondary antenna.

Exemplary embodiments of the present invention provide a terminal including a main ground; a primary antenna disposed on a first portion of the main ground; a secondary antenna disposed on a second portion of the main ground; a first dummy ground disposed within a reference proximity to the primary antenna; and a secondary dummy ground disposed within a reference proximity to the secondary antenna.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an arrangement structure of a plurality of antennas and a ground in a general terminal.

FIG. 2 illustrates an arrangement structure of a plurality of antennas and a ground in a general terminal.

FIG. 3 is a circuit diagram schematically illustrating a part of a terminal with a plurality of antennas according to an exemplary embodiment of the present invention.

FIG. 4 illustrates arrangement structures of dummy grounds when antennas of FIG. 3 are disposed in parallel according to an exemplary embodiment of the present invention.

FIG. 5 is a graph illustrating an Envelope Correlation Coefficient (ECC) calculated for each arrangement structure illustrated in FIG. 4.

FIG. 6 is a graph illustrating a primary antenna gain calculated for each arrangement structure illustrated in FIG. 4.

FIG. 7 is a graph illustrating a secondary antenna gain calculated for each arrangement structure illustrated in FIG. 4.

FIG. 8 illustrates arrangement structures of dummy grounds when two antennas are disposed perpendicular to each other.

FIG. 9 is a graph illustrating a phase difference and an ECC calculated for each arrangement structure illustrated in FIG. 8.

FIG. 10 is a table illustrating an ECC calculated for each arrangement structure illustrated in FIG. 8.

FIG. 11 is a graph illustrating return loss and isolations of antennas when dummy grounds are arranged as shown in (e) of FIG. 8.

FIG. 12 is a graph illustrating a comparison of an ECC calculated for the structure (a) of FIG. 8 to an ECC calculated for the structure (e) of FIG. 8.

FIG. 13 is a graph illustrating a comparison of a primary antenna gain calculated for the structure (a) of FIG. 8 to a primary antenna gain calculated for the structure (e) of FIG. 8.

FIG. 14 is a graph illustrating a comparison a secondary antenna gain calculated for the structure (a) of FIG. 8 to a secondary antenna gain calculated for the structure (e) of FIG. 8.

FIG. 15 illustrates radiating patterns for arrangement structures of dummy grounds when two antennas are disposed perpendicular to each other according to an exemplary embodiment of the present invention.

FIG. 16 is a table illustrating antenna gains and an ECC calculated for each arrangement structure illustrated in FIG. 15.

FIG. 17 is a flowchart illustrating a method for switching on/off dummy grounds of a terminal according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Prior to describing exemplary embodiments of the present invention, for easy understanding, the meanings of Envelope Correlation Coefficient (ECC) and isolation, and differences therebetween will be described below. In an example, the ECC may refer to a correlation between complex patterns of primary antennas and secondary antennas, which may be an index for determining similarity between the radiating patterns of the two antennas or for determining differences in magnitude and phase between the radiating patterns. The ECC may have a value between 0 and 1. In an ideal Multi-Input Multi-Output (MIMO) array antenna having no similarity between antenna elements, the ECC may be 0. If the ECC approaches a value of 1, it may be recognized that there is only one antenna, regardless of field intensity. Accordingly, an ECC of 0.5 or less may be recommended.

Isolation may refer to an index for representing how much energy may be exchanged between antennas, more specifically, a degree of influence between antennas. Accordingly, when antennas are located within a reference proximity to each other, isolation may become poor. Isolation may not be used to extract correlation between complex patterns, and may be used to estimate an amount of transferred energy. Accordingly, an ECC may refer to an actual index for estimating data throughput, rather than isolation. More particularly, at a lower frequency band, since the radiating patterns of antennas are easy to be similar to each other, regardless of the locations of the antennas, an ECC becomes relatively great.

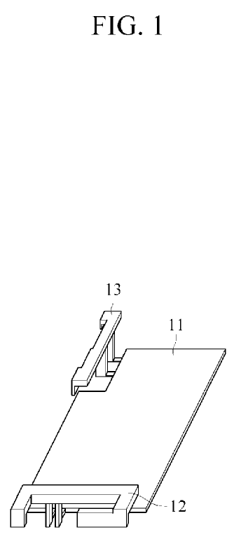

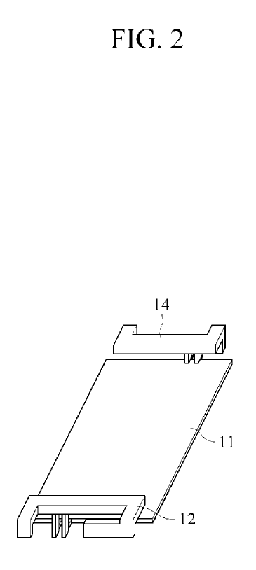

FIG. 1 illustrates an arrangement structure of a plurality of antennas and a ground in a general terminal. FIG. 2 illustrates an arrangement structure of a plurality of antennas and a ground in a general terminal. Referring to FIG. 1 and FIG. 2, a terminal with a plurality of antennas includes a main ground 11, and a primary antenna 12, a secondary antenna 13 of FIG. 1, and a secondary antenna 14 of FIG. 2. The primary antenna 12, the secondary antenna 13, and the secondary antenna 14 may be connected to the main ground 11 to ground the main ground 11. Referring to FIG. 1, two antennas, the primary antenna 12 and the secondary antenna 13 are disposed perpendicular to each other and connected to the main ground 11. More specifically, the primary antenna 12 is connected to a first portion of the main ground 11, and the secondary antenna 13 is connected to a second portion of the main ground 11. Referring to FIG. 1, the second portion may refer to an upper portion, however, aspects of the invention are not limited thereto, such that the second portion may also refer to an upper side portion or a side portion that extends parallel to a plane in which the main ground 11 extends. Here, the first portion may refer to an end portion or an edge portion that extends in a direction perpendicular to a plane in which the main ground 11 extends, and the second portion may refer to an end portion or an edge portion that extends in a direction parallel to a plane in which the main ground 11 extends. For example, the first portion may refer to a lower end portion or edge portion that extends in a direction perpendicular to a plane in which the main ground 11 extends, and the second portion may refer to an upper end portion or edge portion that extends in a direction perpendicular to the plane in which the main ground 11 extends. Further, the primary antenna 12 may extend in a direction normal to a plane in which the main ground 11 extends, and the secondary antenna 13 may extend in a direction parallel to a plane in which the main ground 11 extends. However, aspects of the invention are not limited thereto, such that at least one of the first portion and the second portion may be an end portion or an edge (e.g., an upper portion/edge, a lower portion/edge, a side portion/edge, and the like).

Referring to FIG. 2, two antennas, the primary antenna 12 and the secondary antenna 14 are disposed in parallel and connected to the main ground 11. More specifically, the primary antenna 12 and secondary antenna 14 may extend in a direction normal to the plane in which the main ground 11 extends. Here, the primary antenna 12 is connected to a lower end portion or the first portion of the main ground 11, and the secondary antenna 12 is connected to an upper end portion or the second portion of the main ground 11.

In the terminal with the plurality of antennas, each antenna may be a MIMO antenna or a Diversity antenna. Referring to a MIMO method, a base station and a mobile is terminal may each have two or more antennas to transmit data through a plurality of paths, and a receiving port to detect signals received through the respective paths. Referring to a Diversity method, two or more antennas may receive and synthesize signals, and then detect the synthesized signal as a received signal. Since both the MIMO method and Diversity method may be implemented with a plurality of antennas, the MIMO method and the Diversity method may be applied to terminals having the same or similar arrangement structure of antennas. However, the Diversity method may be different from the MIMO method in that signals inputted/outputted through antennas are processed.

Also, in the terminal with the plurality of antennas, each antenna may be a Multi-Input Single-Output (MISO) or Single-Input Single-Output (SISO) antenna. However, aspects of the invention are not limited thereto, such that an antenna of a different type based on one of various input systems and output systems, which may be implemented with a plurality of antennas. The individual antennas may support the same frequency band or different frequency bands.

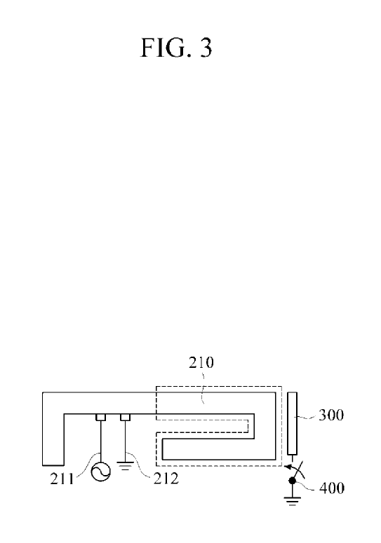

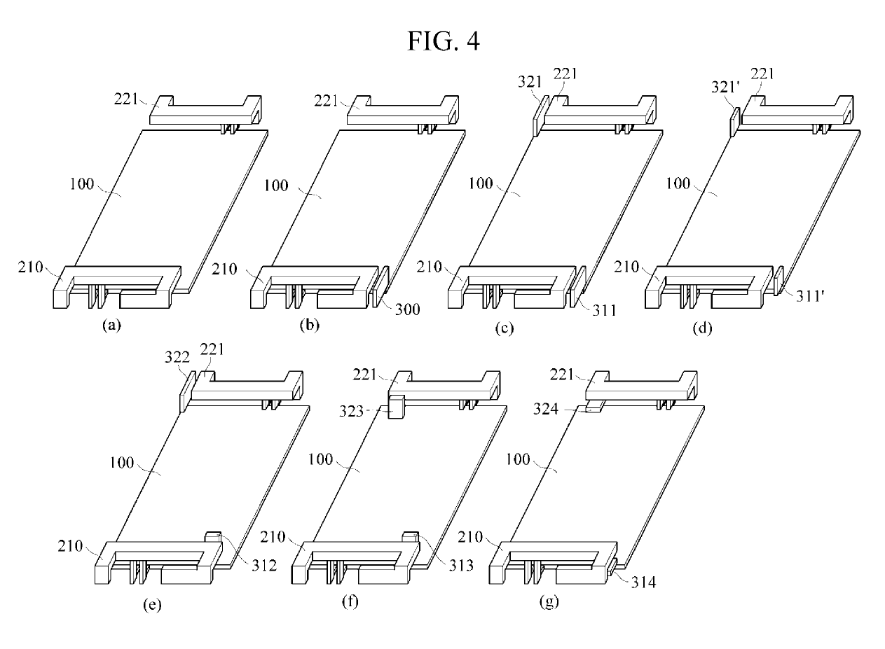

FIG. 3 is a circuit diagram schematically illustrating a part of a terminal with a plurality of antennas according to an exemplary embodiment of the present invention. FIG. 4 illustrates arrangement structures of dummy grounds when antennas of FIG. 3 are disposed in parallel according to an exemplary embodiment of the present invention.

Referring to FIG. 3 and FIG. 4, a terminal may include a ground and a plurality of antennas. One or more antennas include a radiating antenna 210, a feed line 211, and a ground line 212. The radiating antenna 210 may receive or transmit radio frequency (RF) signals in the corresponding frequency band. Also, the feed line 211 may connect the radiating antenna 210 to a power supply of a printed circuit board, and the ground line 212 may connects the radiating antenna 210 to a ground of the printed circuit board.

Further, the terminal includes a main ground 100 formed on a substrate, a primary antenna 210 connected to a first portion or one end of the main ground 100, a secondary antenna 221 connected to a second portion or the other end of the main ground 100, and a dummy ground 300 disposed within a reference proximity to at least one of the primary antenna 210 and/or the secondary antenna 221. The main ground 100 may be grounded by the dummy ground 300.

More specifically, instead of providing separate ground for each of the primary antenna 210 and the secondary antenna 221, each of these antennas may be commonly grounded to the main ground 100. The main ground 100 may be formed in the shape of a rectangle on the substrate of the terminal, as described above, and the substrate itself may act as the main ground 100. The primary antenna 210 and the secondary antenna 221 may be radiating elements for a low frequency band that produce a low-band resonance, for a high frequency band that produce high-band resonance, or for a broad band that produce both low-band resonance and high-band resonance. The primary antenna 210 and the secondary antenna 221 may be disposed in parallel or perpendicular to each other, respectively, at a first portion and a second portion of the main ground 100. More specifically, in an example, the primary antenna 210 and the secondary antenna 221 may be disposed parallel to each other. In another example, the primary antenna 210 and the secondary antenna 221 may be disposed perpendicular to each other. Further, the first portion may refer to an upper end portion and the second portion may refer to a lower end portion of the main ground 100. However, aspects of the invention are not limited thereto, such that the first portion may refer to an end portion or an edge portion that extends in a direction perpendicular to a plane in which the main ground 100 extends, and the second portion may refer to an end portion or an edge portion that extends in a direction parallel to a plane in which the main ground 100 extends.

The primary antenna 210 and the secondary antenna 221 may be disposed at a reference separation distance with respect to one another in order to avoid potential interference that may be present therebetween. The primary antenna 210 and one of the secondary antenna 221 may be disposed, for example, at opposite ends of the terminal, such as a first end and a second end, however, aspects need not be limited thereto. The primary antenna 210 and one of the secondary antenna 221 may communicate with a base station through, without limitation, at least one of the MIMO method, the Diversity method, the MISO method, the SISO method, or any other method that can be implemented with a plurality of antennas. Also, the individual antennas, including the primary antenna 210 and the secondary antenna 221, may support the same frequency band or different frequency bands.

The dummy ground 300 is disposed at a reference proximity to at least one of the primary antenna 210 and the secondary antenna 221. The dummy ground 300 may ground the main ground 100 through coupling, direct-connection, switching, and the like. Further, the dummy ground 300 may be formed with a predetermined shape of wire, a predetermined shape of board, or any other shape in correspondence to the structure of the terminal. The dummy ground 300 may be positioned vertical to the main ground 100, e.g., may extend in a direction normal to a plane in which the main ground 100 extends, and the dummy ground 300 may also be disposed within a reference proximity to one end portion of at least one of the primary antenna 210 and the secondary antenna 221. Further, the dummy ground 300 may be disposed, without limitation in front of, behind, above, or under at least one of the primary antenna 210 and the secondary antenna 221. The arrangement structure of the dummy ground 300 may be determined in consideration of at least one of the range of a frequency band of interest, ECC, antenna performance, and the like. The dummy ground 300 may be used when an ECC is poor, even at a high frequency band higher than 1 gigahertz (GHz). Therefore, the antenna system according to exemplary embodiments of the present invention can improve antenna characteristics by reducing an ECC value, and not by improving isolation characteristics like a conventional technique. Accordingly, no symmetrical antenna pattern for improving isolation may be used, and the ECC value may be reduced by adding one or more dummy grounds to an antenna. Further, the dummy ground may be added without having to form slots or add parasitic elements to a substrate, and without having to change a pattern implemented in a mobile terminal. Data and tables related to the reduction of ECC improvement according to the arrangement locations of the primary antenna 210 and the secondary antenna 221 will be described in more detail below.

In an example, an ECC may be calculated in consideration of antenna performance improvement according to a change in a phase in a multi-antenna environment using Equation 1 below.

$$\text{?} = \frac{{\vert \text{?} \text{?} {E}_{1}^{*} ( θ , φ ) \text{?} {E}_{2} ( θ , φ ) \cdot P ( θ , φ ) \cdot Sin ( θ ) \cdot d θ \cdot d φ \vert}^{2}}{\begin{matrix}( \text{?} \text{?} {E}_{1}^{*} ( θ , φ ) {E}_{1} ( θ , φ ) \text{?} P ( θ , φ ) \cdot Sin ( θ ) \cdot d θ \cdot d φ ) \cdot \\ ( \text{?} \text{?} ( θ , φ ) \text{?} ( θ , φ ) \cdot P ( θ , φ ) \cdot Sin ( θ ) \cdot d θ \cdot d φ )\end{matrix}} \\ \text{?} \text{indicates text missing or illegible when filed} \qquad ( 1 )$$

In Equation 1, E₁(θ, φ) and E₂(θ, φ) may refer to a complex pattern of the primary antenna 210 and a complex pattern of the secondary antenna 221, respectively, and p(θ, φ) may refer to a distribution value of a signal incoming from a base station with respect to an angle.

According to Equation 1, since the ECC is calculated using complex numbers, phase values, and the like, (E′, θ, φ), the complex patterns for the antennas, may show that the ECC is affected by the magnitudes of radiating patterns, and phase values.

In an example, the dummy ground 300 includes a switching device 400 to connect/disconnect the dummy ground 300 to/from the main ground 100. The switching device 400 has a configuration for electrically connecting to or disconnecting from the main ground 100, and may be a Single Pole Double Throw (SPDT) switch, a semiconductor stack of P-type, intrinsic, and N-type material (PIN) diode switch, or the like. If the switching device 400 is turned on/off to connect/disconnect the dummy ground 300 to/from the main ground 100, an antenna gain and/or an ECC may be changed. Accordingly, by controlling the switching device 400 selectively according to a wireless communication environment, transmission/reception quality of RF signals may be maintained above a reference threshold. Also, in order to adjust the degree of coupling of the dummy ground 300, a plurality of switching devices that can be independently controlled may be provided. More specifically, by changing the number of switching devices that may be controlled, the degree of coupling of the dummy ground 300 may be adjusted.

In an example, the primary antenna 210 and the secondary antenna 221 may be disposed in a horizontal direction at the upper end portion and the lower end portion of the main ground 100, respectively, such that the primary antenna 210 may face the secondary antenna 221. However, aspects of the invention are not limited thereto, such that the primary antenna 210 and the secondary antenna 221 may be disposed to be perpendicular to one another. Accordingly, at least one of the primary antenna 210 and the secondary antenna 221 may be disposed at the upper end portion or a first end portion, the lower end portion or the second end portion, a left end portion or a third end portion, or a right end portion or a fourth end portion of the main ground 100. Further, the primary antenna and the secondary antenna are not limited to end portions or edge portions of the main ground 100, and may be disposed at various portions thereof.

Referring to (a) of FIG. 4, no dummy ground is provided within a proximity of the primary antenna 210 and the secondary antenna 221 disposed in parallel to each other. More specifically, the structure (a) of FIG. 4 corresponds to a conventional structure with a plurality of antennas.

Referring to (b) of FIG. 4, a dummy ground 300 is disposed within a reference proximity to only the primary antenna 210. However, aspects of the invention are not limited thereto, such that the dummy ground 300 may be disposed within a reference proximity to the secondary antenna 221, instead of the primary antenna 210, or the dummy ground 300 may be disposed to be within reference proximity of both the primary antenna 210 and the secondary 221. As shown in (b) of FIG. 4, the dummy ground 300 is disposed within a reference proximity to an end portion of the primary antenna 210, but is not limited thereto.

Referring to (c) of FIG. 4, a first dummy ground 311 is disposed within a reference proximity to the right end portion of the primary antenna 210, and a second dummy ground 321 is disposed within a reference proximity to a left end portion of the secondary antenna 221. Similar to the example above, at least one of the first dummy ground 311 and the second dummy ground 321 may be disposed within a reference proximity to an upper end portion or a first end portion, a lower end or a second end portion, a left end portion or a third end portion, and a right end portion or a fourth end portion of one of the primary antenna 210 or the secondary antenna 221.

The first dummy ground 311 and the second dummy ground 321 are disposed vertically on the main ground 100 with respect a direction in which the main ground 100 extends and are disposed at opposite or diagonal corners of the main ground 100 from each other. Referring to (d) of FIG. 4, a first dummy ground 311′ and a second dummy ground 321′ are configured similar to a structure of (c) of FIG. 4, but the first dummy ground 311′ and the second dummy ground 321′ are smaller or shorter in length or width than the first dummy ground 311 and the second dummy ground 321 of (c) of FIG. 4 such that the first dummy ground 311′ and the second dummy ground 321′ extend along the first end portions of the primary antenna 210 and the secondary antenna 221 for a shorter distance than the first dummy ground 311 and the second dummy ground 321.

Referring to (e) of FIG. 4, a first dummy ground 312 is disposed within a reference proximity to the first end portion of the primary antenna 210 to face inwards toward a central region of the main ground 100. The first surface of the primary antenna 210 may face inwards toward a central region of the main ground 100 and may be perpendicular to a top surface of the main ground 100. A second dummy ground 322 is disposed within a reference proximity to a third end portion of the secondary antenna 221, similar to (c) of FIG. 4. The first dummy ground 312 may be smaller or shorter in length than the second dummy ground 322, and disposed to extend in a direction perpendicular to a direction in which the second dummy ground 322 extends. Further, the first dummy ground 311 and the second dummy ground 321 are disposed vertically on the main ground 100 with respect a direction in which the main ground 100 extends and are disposed at opposite or diagonal corners of the main ground 100 from each other.

Referring to (f) of FIG. 4, a first dummy ground 313 is disposed within a reference proximity of the first end portion of the primary antenna 210 to face inwards toward a central region of the main ground 100, similar to (e) of FIG. 4. A second dummy ground 323 is disposed within a reference proximity to the second end portion of the secondary antenna 221 to face inwards towards a central region of the main ground 100. A surface of the secondary antenna 221 may face inwards toward a central region of the main ground 100 and may extend perpendicular or in a direction normal to a plane in which the main ground 100 extends. The dummy grounds of (f) of FIG. 4 may be smaller or shorter in length than the dummy grounds in (c) of FIG. 4. Further, the first dummy ground 311 and the second dummy ground 321 are disposed vertically on the main ground 100 with respect a direction in which the main ground 100 extends and are disposed at opposite or diagonal corners of the main ground 100 from each other.

Referring to (g) of FIG. 4, a first dummy ground 314 is disposed below a bottom surface of the primary antenna 210 and a top surface of the main ground 100. More specifically, the dummy ground 314 is disposed between the primary antenna 210 and the main ground 100.

Similarly, a second dummy ground 324 is disposed below a bottom surface of the secondary antenna 221 and a top surface of the main ground 100. Further, the first dummy ground 311 and the second dummy ground 321 are disposed vertically on the main ground 100 with respect a direction in which the main ground 100 extends and are disposed at opposite or diagonal corners of the main ground 100 from each other.

Although some of the dummy grounds of (d) of FIG. 4, (e) of FIG. 4, (f) of FIG. 4, and (g) of FIG. 4 are shown to be smaller or shorter in length than the dummy grounds of (c) of FIG. 4, they are not limited thereto, such that the respective dummy grounds may be the same size or larger than the dummy grounds of (c) of FIG. 4, and other combinations of dummy grounds may be available. Further, although not illustrated, dummy grounds may also be disposed above the top surface of at least one of the primary antenna 210 and the secondary antenna 221.

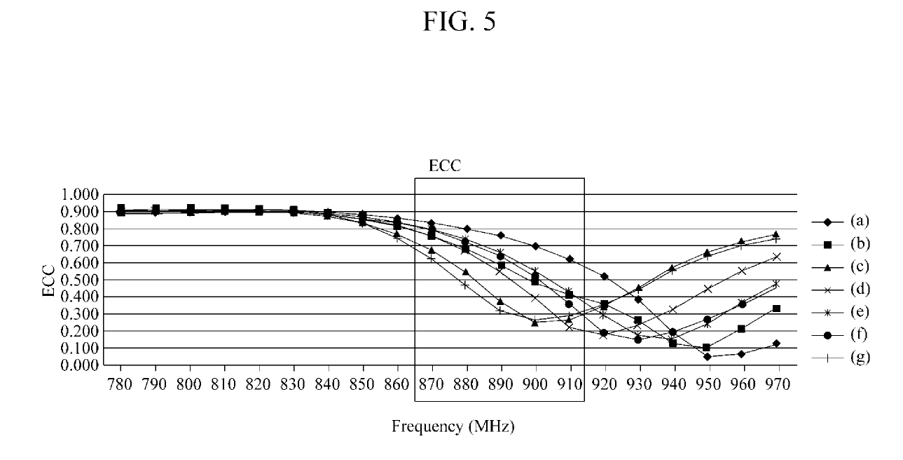

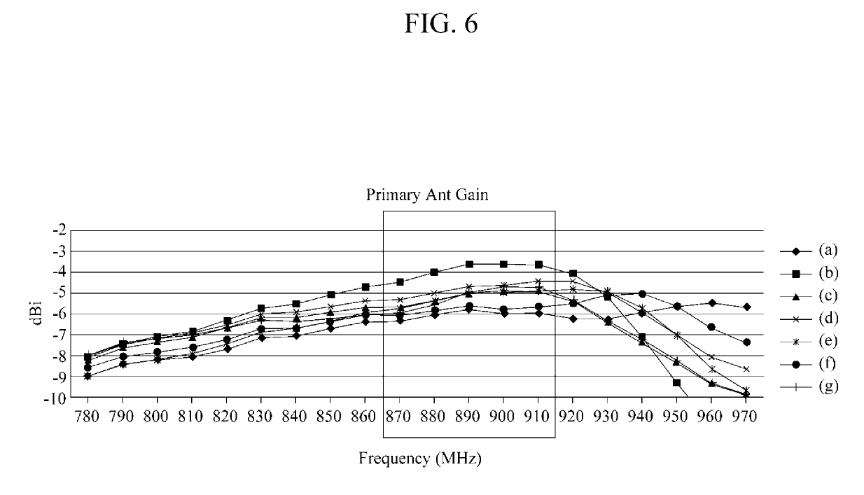

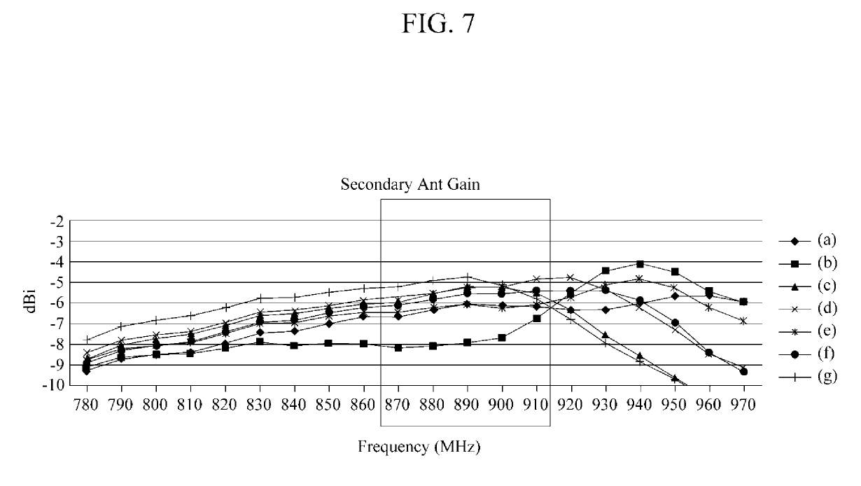

FIG. 5 is a graph illustrating an ECC calculated for each arrangement structure illustrated in FIG. 4. FIG. 6 is a graph illustrating a primary antenna gain calculated for each arrangement structure illustrated in FIG. 4. FIG. 7 is a graph illustrating a secondary antenna gain calculated for each arrangement structure illustrated in FIG. 4. FIG. 5, FIG. 6, and FIG. 7 will be discussed with respect to a frequency band of 870 MHz to 910 MHz, which may be indicated by an enclosed box drawn with respect to the identified frequency range.

Referring to FIG. 5, FIG. 6, and FIG. 7, the improved effects of ECC and antenna gains based on addition of dummy grounds may be visually verified. First, if an ECC calculated for the structure (a) of FIG. 4, in which no dummy ground is provided, is compared to an ECC calculated for the structure (b) of FIG. 4, in which the dummy ground 300 is disposed within a reference proximity to the primary antenna 210, the ECC corresponding to the structure (b) of

FIG. 4 is smaller than the ECC corresponding to the structure (a) of FIG. 4. Similarly, it may be seen that the ECC corresponding to structures of (c) of FIG. 4, (d) of FIG. 4, (e) of FIG. 4, (f) of FIG. 4, and (g) of FIG. 4 is lower than the ECC corresponding to (a) of FIG. 4.

Referring to FIG. 6, antenna gain of the primary antenna 210 within a reference proximity to the dummy ground 300 corresponding to the structure (b) of FIG. 4 is greater than that of the primary antenna 210 of the structure (a) of FIG. 4. Similarly, antenna gain of the primary antenna 210 corresponding to the structures (c) of FIG. 4, (d) of FIG. 4, (e) of FIG. 4, (f) of FIG. 4, and (g) of FIG. 4 are greater than the antenna gain corresponding to the structure (a) of FIG. 4.

When dummy grounds are respectively disposed within a reference proximity to the primary antenna 210 and the secondary antenna 221 that may be disposed in parallel, the possible arrangement structures of the dummy grounds, and the improved effects of ECC and antenna gains according to the arrangement structures of the dummy grounds will be described in detail with reference to FIG. 4, FIG. 5, FIG. 6, and FIG. 7.

In an example, a first dummy ground 311 is disposed within a reference proximity to a first end portion of the primary antenna 210, and a second dummy ground 321 that is disposed within a reference proximity to a second end portion of the secondary antenna 221, such that the second dummy ground 321 is diagonally disposed with respect to the first dummy ground 311. The grounding surfaces of the first dummy ground 311 and the second dummy ground 321 face outward, such that the primary antenna 210 and the secondary antenna 221 are grounded in different directions. In an example, the grounding surface may refer to a lateral side of a dummy ground in which the dummy ground extends.

Referring to (c) of FIG. 4 and (d) of FIG. 4, dummy ground 311′ and dummy ground 321′ shown in (d) of FIG. 4 may have a smaller size than those of the dummy ground 311 and the dummy ground 321 shown in (c) of FIG. 4. The dummy ground 311′ and the dummy ground 321′ may be approximately half of a size of the dummy ground 311 and the dummy ground 321, respectively. As such, since the grounding surfaces face outward and the primary antenna 210 and the secondary antenna 210 and the secondary antenna 221 are grounded in different directions, the improved effects of ECC and antenna gains may be seen. More specifically, the results of comparison between the structure (a) of FIG. 4 and the structures (b) of FIG. 4 and (c) of FIG. 4 illustrate that the ECCs calculated for the structures (b) of FIG. 4 and (c) of FIG. 4 are smaller than the ECC calculated for the structure (a) of FIG. 4. Further, the structures (b) of FIG. 4 and (c) of FIG. 4 acquire improved gains of the primary antenna and the secondary antennas compared to the structure (a) of FIG. 4. Also, the result of comparison between the structure (b) of FIG. 4 and the structure (c) of FIG. 4 illustrates that the improved effects of ECC and antenna gains are reduced as the sizes of the first dummy ground 311 and the second dummy ground 321 are reduced.

Referring to (e) of FIG. 4, a first dummy ground 312 is disposed in front of the primary antenna 210, such that the grounding surface of the first dummy ground 312 faces the secondary antenna 221. Further, a second dummy ground 322 is disposed within a reference proximity to a lateral side of the secondary antenna 221, such that the grounding surface of the second dummy ground 322 faces outward. Referring to (f) of FIG. 4, a first dummy ground 313 and a second dummy ground 323 are disposed in front of the primary antenna 210 and the secondary antenna 221, respectively, such that the grounding surfaces of the first dummy ground 313 and the second dummy ground 323 face each other, inwards toward a central region of the main ground 100. Referring to (g) of FIG. 4, a first dummy ground 314 and a second dummy ground 324 are disposed under the primary antenna 210 and the secondary antenna 221, respectively.

In all the structures of (b) of FIG. 4, (c) of FIG. 4, (d) of FIG. 4, (e) of FIG. 4, (f) of FIG. 4, and (g) of FIG. 4, the improved effects of ECC and gains of the primary antenna 210, secondary antenna 221, and the secondary antenna 221 have been verified compared to the case (a) of FIG. 4, in which no dummy ground is provided. More specifically, referring to FIG. 5, the structures (c) of FIG. 4 and (g) of FIG. 4 can be used to acquire an improved ECC in a frequency band of interest. In more detail, the structure (a) of FIG. 4 can acquire an ECC of 0.757, whereas the structures (c) of FIG. 4 and (g) of FIG. 4 can acquire ECCs of 0.376 and 0.318, respectively.

Referring to FIG. 6 and FIG. 7, in view of antenna gains, the primary antenna 210 in the structure (a) of FIG. 4 can acquire gain of −5.8 decibel isotropic (dBi), whereas the primary antenna 210 in the structures (c) of FIG. 4 and (g) of FIG. 4 can acquire gains of −5.0 dBi and −4.8 dBi, respectively. Likewise, the secondary antenna 221 in the structure (a) of FIG. 4 can acquire gain of −6.1 dBi, whereas the secondary antenna 221 in the structures (c) of FIG. 4 and (g) of FIG. 4 can acquire gains of −5.2 dBi and −4.7 dBi, respectively. Also, since the ECC, and the antenna gains of the primary antenna and the secondary antennas can be changed by turning on/off the switch 400 of the dummy ground 300, it may be possible to enhance the performance of the primary antenna 210, the secondary antenna 221, and the secondary antenna 221 by turning on/off the switch 400 selectively according to a wireless communication environment.

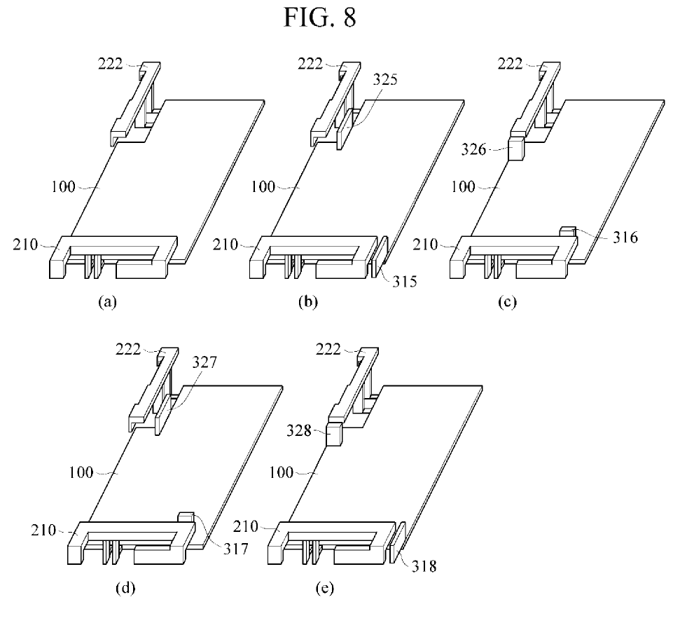

FIG. 8 illustrates arrangement structures of dummy grounds when two antennas are disposed perpendicular to each other.

Referring to FIG. 8, the primary antenna 210 is disposed in a horizontal direction, e.g., parallel with an end of the main ground 100, on an end portion of the main ground 100, such as one of the upper end or lower end of a main ground 100, and the secondary antenna 222 is disposed perpendicular to the primary antenna 210 on a side of an end portion of the main ground 100, such as one of the left side or right side of the main ground 100. Referring to (a) of FIG. 8, no dummy ground is provided in the provided structure. Referring to (b) of FIG. 8, (c) of FIG. 8, (d) of FIG. 8, and (e) of FIG. 8 illustrate structures where dummy grounds are provided within reference proximity to both the primary antenna 210 and the secondary 222, respectively. However, aspects of the invention are not limited thereto, such that a primary antenna 210 and a secondary antenna 222 may be disposed on the main ground 100 at various orientations with respect to one another. Further, the primary antenna and the secondary antennas may not be limited to being disposed on an end portion or a side of the end portion of the main antenna.

Referring to (b) of FIG. 8, a first dummy ground 315 is disposed within a reference proximity to the fourth end portion of the primary antenna 210, such that the grounding surface of the first dummy ground 315 faces outward towards a right side, and a second dummy ground 325 is disposed within a reference proximity to the fourth end portion the secondary antenna 222 towards interior region of the main ground 100, such that the first dummy ground 315 and the second dummy ground 325 are disposed at opposite corners. Accordingly, the grounding surface of the second dummy ground 325 may face the grounding surface of the first dummy ground 315 diagonally. In an example, the grounding surface may refer to a lateral side of a dummy ground in which the dummy ground extends.

Also, referring to (c) of FIG. 8, a first dummy ground 316 is disposed in front of the first end portion of the primary antenna 210, such that the grounding surface of the first dummy ground 316 faces inward towards interior region of the main ground 100, and a second dummy ground 326 that is disposed within a reference proximity to the second end portion of the secondary antenna 222, such that the grounding surface of the second dummy ground 326 faces the first dummy ground 316 in parallel.

Also, referring to (d) of FIG. 8, a first dummy ground 317 is disposed in front of the first end portion the primary antenna 210, such that the grounding surface of the first dummy ground 317 faces inward towards interior region of the main ground 100, and a second dummy ground 327 is disposed in front of the fourth end portion of the secondary antenna 222, such that the grounding surface of the second dummy ground 327 is positioned perpendicular to the first dummy ground 317.

Also, referring to (e) of FIG. 8, a first dummy ground 318 is disposed within a reference distance to the fourth end portion of the primary antenna 210, such that the grounding surface of the first dummy ground 318 faces outward away from the main ground 100, and a second dummy ground 328 is disposed within a reference proximity to the second end portion of the secondary antenna 222, such that the grounding surface of the second dummy ground 328 is positioned perpendicular to the grounding surface of first dummy ground 318.

The possible arrangement structures of the dummy grounds, and the improved effects of ECC and antenna gains according to the arrangement structures of the dummy grounds when dummy grounds are respectively disposed within a reference proximity to both the primary antenna and the secondary antenna disposed perpendicular to each other, will be described in more detail.

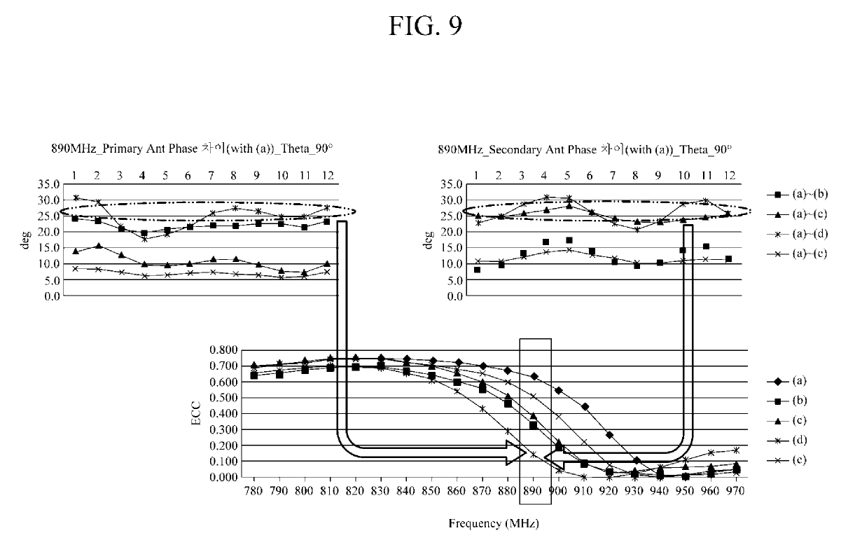

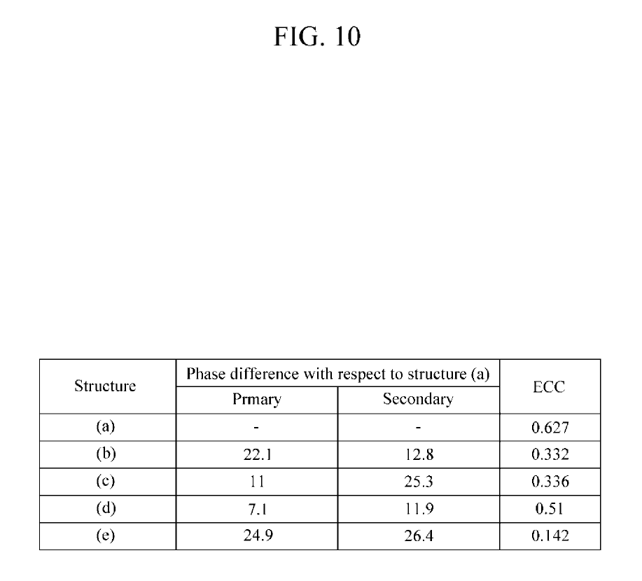

FIG. 9 is a graph showing a phase difference and an ECC of each arrangement structure illustrated in FIG. 8. More specifically, FIG. 9 provides a phase difference of a primary antenna and a secondary antenna at 890 MHz Theta 90°. FIG. 10 is a table illustrating an ECC calculated for each arrangement structure illustrated in FIG. 8.

Referring to FIG. 9 and FIG. 10, the structures (b) of FIG. 8, (c) of FIG. 8, (d) of FIG. 8, and (e) of FIG. 8, in which dummy grounds are arranged within a reference proximity to both the primary antenna 210 and the secondary antenna 222, may acquire changes in a phase of a radiation signal of an antenna from 7.1° to 26.4° and reduced ECCs in comparison to the structure (a) of FIG. 8, in which no dummy ground is provided. Also, the structure (e) of FIG. 8 may acquire the most significant change in the phase of a radiation signal of an antenna among the structures of FIG. 8 incorporating the dummy ground (i.e., (b) of FIG. 8, (c) of FIG. 8, (d) of FIG. 8, and (e) of FIG. 8), when compared to the structure (a) of FIG. 8 where no dummy ground is provided. The structure (e) of FIG. 8 can acquire a smaller ECC when compared to structure (a) of FIG. 8. The structure (d) of FIG. 8 can acquire the smallest change in phase of a radiation signal of an antenna among the structures of FIG. 8 incorporating the dummy ground (i.e., (b) of FIG. 8, (c) of FIG. 8, (d) of FIG. 8, and (e) of FIG. 8), when compared to the structure (a) of FIG. 8, and also acquire the smallest reduction in an ECC among the structures of FIG. 8. As a result, the greater the difference in the phase of a radiation signal of an antenna in a structure using a dummy ground when compared to the structure (a) of FIG. 8, the ECC is correspondingly reduced. More specifically, ECC may be improved.

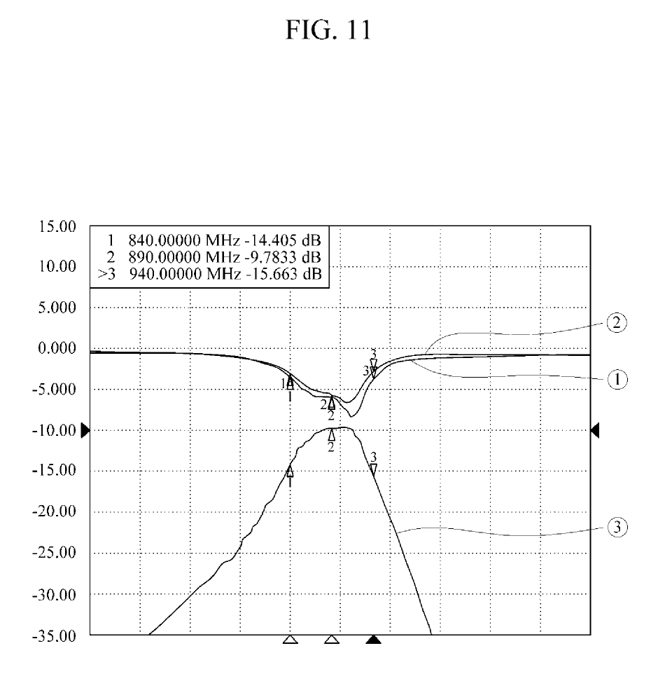

FIG. 11 is a graph illustrating return loss and isolations of antennas when dummy grounds are arranged as shown in (e) of FIG. 8. Referring to FIG. 11, \textcircled{1} may refer to a return loss of a primary antenna 210, \textcircled{0} may refer to a return loss of a secondary antenna 222, and \textcircled{3} may refer to an isolation value of the primary antenna 210 and the secondary antenna 222.

The graph shown in FIG. 11 may be similar to a graph corresponding to when no dummy ground is provided. More specifically, it may be determined that an ECC is reduced and isolation values are improved due, at least in part, to addition of dummy grounds, as seen from the graphs of FIG. 9. As shown in FIG. 11, at data point 1, an isolation value of −14.405 dB is measured at 840.00000 MHz frequency band, at data point 2, an isolation value of −9.7833 dB is measured at 890.00000 MHz frequency range, and at data point 3, an isolation value of −15.663 dB is measured at 940.00000 MHz frequency range.

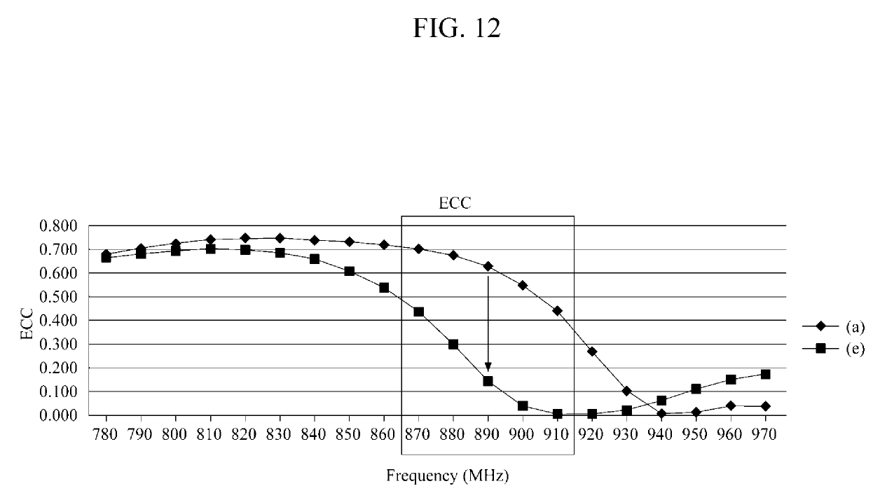

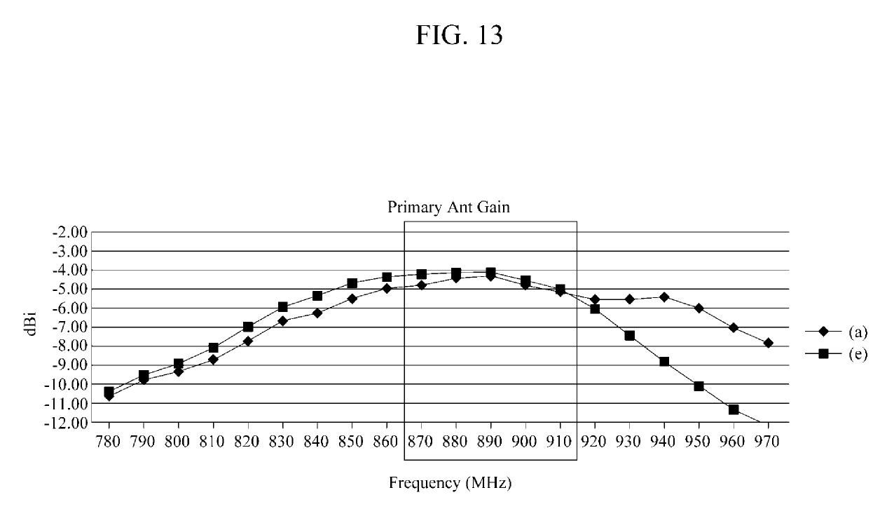

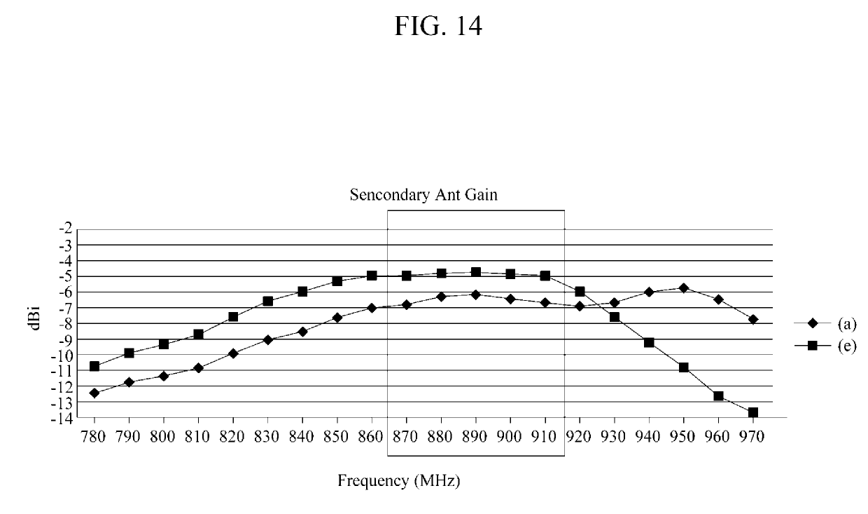

FIG. 12 is a graph illustrating a comparison of an ECC calculated for the structure (a) of FIG. 8 to an ECC calculated for the structure (e) of FIG. 8. FIG. 13 is a graph illustrating a comparison of a primary antenna gain calculated for the structure (a) of FIG. 8 to a primary antenna gain calculated for the structure (e) of FIG. 8. FIG. 14 is a graph illustrating a comparison a secondary antenna gain calculated for the structure (a) of FIG. 8 to a secondary antenna gain calculated for the structure (e) of FIG. 8.

Referring to FIG. 8 and FIG. 12, in a frequency band around 890 megahertz (MHz), the structure (e) of FIG. 8, where the first dummy ground 318 and the second dummy ground 328 are disposed within a reference proximity to the primary antenna 210 and the secondary antenna 222, respectively, and the structure of (e) of FIG. 8 can acquire an improved ECC when compared to the ECC acquired for the structure (a) of FIG. 8 where no dummy ground is provided. Referring to FIG. 8, FIG. 9, and FIG. 10, in the structure (a) of FIG. 8, the ECC is calculated to 0.627 in the frequency of 890 MHz, whereas in the structure (e) of FIG. 8, the ECC has been calculated to 0.142 in the frequency of 890 MHz.

Referring to FIG. 8 and FIG. 13, when the structure (e) of FIG. 8 is compared to the structure (a) of FIG. 8 with respect to the gains of the antennas, including the primary antenna 210 and the secondary antenna 222, the structure (a) of FIG. 8 can acquire the primary antenna gain of −4.4 dBi, whereas the structure (e) of FIG. 8 can acquire the primary antenna gain of −4.2 dBi. Accordingly, a gain increase of 0.2 dBi for the primary antenna 210 is measured between the structures (a) of FIG. 8 and (e) of FIG. 8.

Referring to FIG. 8 and FIG. 14, with respect to the secondary antenna 222, the structure (a) of FIG. 8 can acquire gain of −6.2 dBi, whereas the structure (e) of FIG. 8 can acquire gain of −4.7 dBi. Accordingly, with respect to the secondary antenna 222, a gain increase between the structures (a) of FIG. 8 and (e) of FIG. 8 reaches 1.5 dBi. More specifically, it may be determined that antenna gains increase in a frequency band of interest due, at least in part, to addition of dummy grounds.

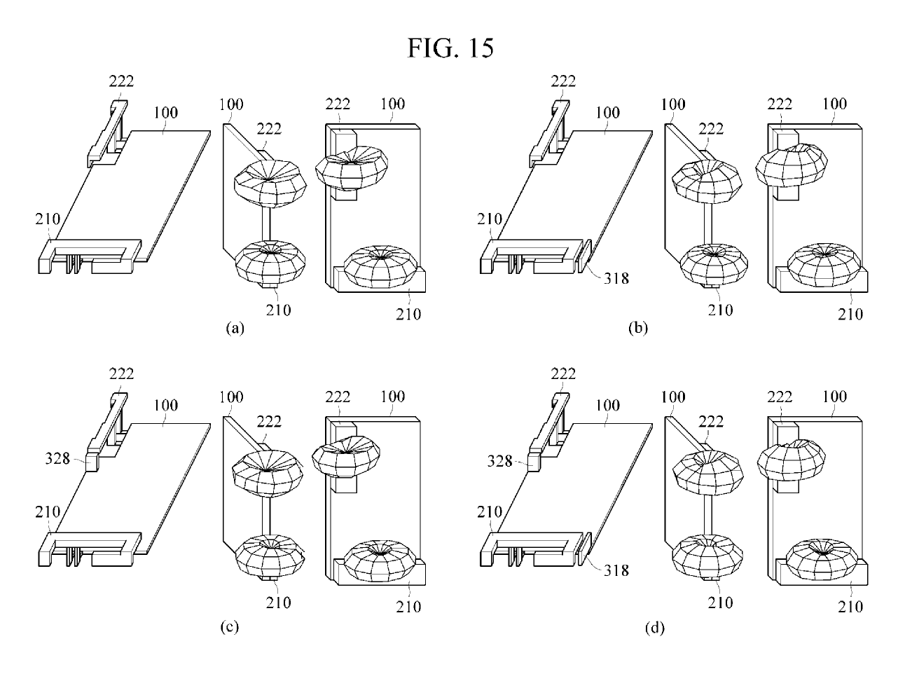

FIG. 15 illustrates radiating patterns for arrangement structures of dummy grounds when two antennas are positioned perpendicular to each other according to an exemplary embodiment of the present invention.

Referring to FIG. 15, when a structure (a) of FIG. 15, in which no dummy ground is provided, is compared to a structure (b) of FIG. 15, in which a dummy ground is disposed within a reference proximity to only a primary antenna 210, antenna gain of the primary antenna 210 of the structure (b) of FIG. 15 increases and antenna gain of the secondary antenna 222 of the structure (b) of FIG. 15 decreases. When the structure (a) of FIG. 15 is compared to a structure (c) of FIG. 15, in which a dummy ground is disposed within a reference proximity to only a secondary antenna 222, antenna gain of the secondary antenna 222 of the structure (c) of FIG. 15 increases and antenna gain of the primary antenna 210 of the structure (c) of FIG. 15 decreases. Further, a structure (d) of FIG. 15, in which dummy grounds are disposed in reference proximity to both the primary antenna 210 and the secondary antenna 222, may acquire both primary antenna gains and secondary antenna gains when compared to the structure (a) of FIG. 15.

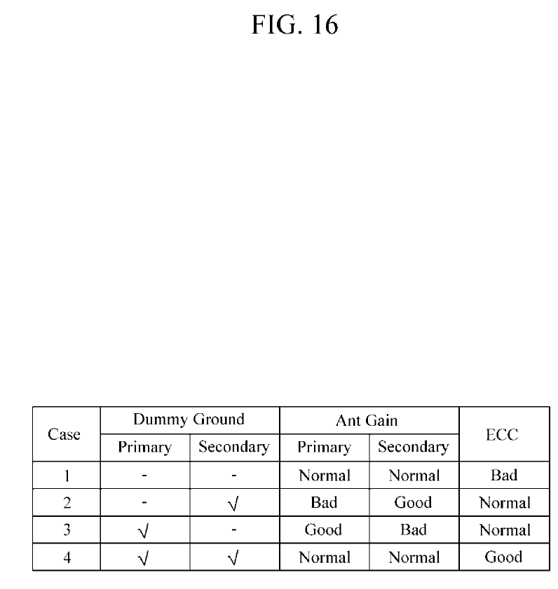

FIG. 16 is a table illustrating antenna gains and an ECC calculated for each arrangement structure illustrated in FIG. 15.

Referring to FIG. 16, the “Dummy Ground” column may indicate whether a dummy ground is disposed within a reference proximity to at least one of the primary antenna or the secondary antenna. If a dummy ground is disposed within a reference proximity to either the primary antenna or the secondary antenna, the corresponding field may be indicated with a “√” mark. If the dummy ground is not disposed within a reference proximity to either the primary antenna or the secondary antenna, the corresponding field may be indicated with a “−” mark.

Case 1 of FIG. 16 corresponds to the structure (a) of FIG. 15, in which no dummy ground is provided. Structure (a) of FIG. 15 may be adopted by a conventional MIMO system. Case 2 of FIG. 16 may correspond to the structure (c) of FIG. 15, in which only the dummy ground 328 of the secondary antenna 222 is grounded. The Case 2 may illustrate that the performance of the primary antenna 210 deteriorates and the performance of the secondary antenna 222 is improved. In Case 3, only the dummy ground 318 of the primary antenna 210 is grounded. Before a mobile terminal is connected to a base station, only a primary antenna of a MIMO antenna system operates, and accordingly, it may be advantageous to increase antenna gain of the primary antenna. Also, the Case 3 may be applied when there is a change in a wireless environment upon the MIMO transmission/reception, for example, when a difficulty is produced by a weak field making transmission to the secondary antenna, or when MIMO transmission/reception becomes inappropriate due to a lack of multipath fading. The Case 3 may be also applied in a frequency band in which no MIMO is used, since only the primary antenna may be used in the frequency band. Case 4 may correspond to a structure, in which the first dummy ground 318 and the second dummy ground 328 of the primary antenna and the secondary antenna 222, respectively, are grounded. The Case 4 may be applied to an environment where MIMO transmission/reception is allowed. When one of the primary antenna 210 and the secondary antenna 222 has greater importance than the other one, the corresponding antenna may maintain a predetermined antenna gain or more. Accordingly, the switch 400 of the dummy ground 300 may be turned on/off with reference to the table shown in FIG. 16. For example, when the performance of the primary antenna 210 has to be higher than that of the secondary antenna 222, a switch of a dummy ground connected to the primary antenna 210 may be turned on, and a switch of a dummy ground connected to the secondary antenna 222 may be turned on/off according to situation. Further, the switch of a first dummy ground 318 may be turned on by default and a switch of the second dummy ground 328 is turned on if the terminal determines that at least one of a MIMO communication, a Diversity communication, and a SISO communication can be performed.

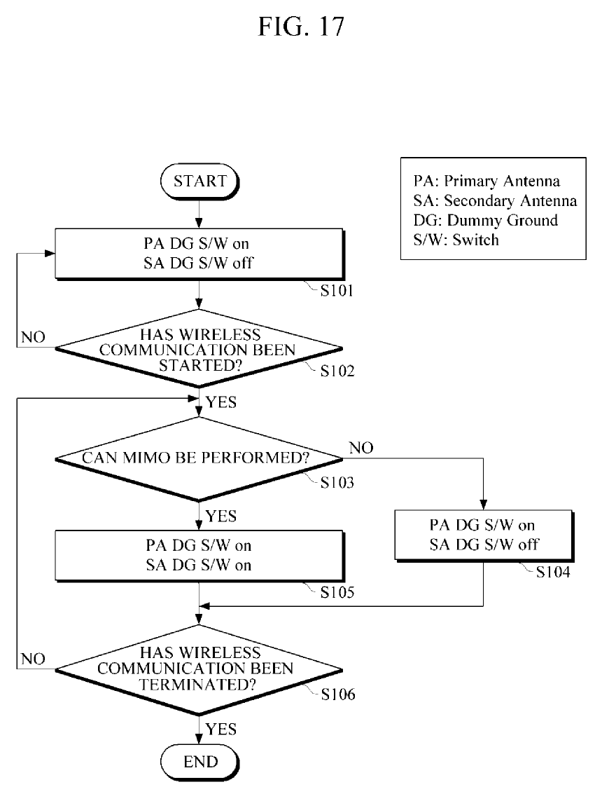

FIG. 17 is a flowchart illustrating an example of a method of switching on/off dummy grounds of a terminal.

A mobile terminal, which attempts to perform wireless communication with a base station, may first exchange its own information with the base station. At this time, generally, only a primary antenna among the primary antenna and a secondary antenna of the mobile terminal may operate. Accordingly, in order to increase an antenna gain of the primary antenna, in operation S101, a switch of a dummy ground connected to the primary antenna is turned on, and a switch of a dummy ground connected to a secondary antenna is turned off. The on/off states of the switches may be maintained until wireless communication between the mobile terminal and the base station is performed. The turned-on dummy ground operates as a dummy ground, and the turned-off dummy ground may not operate as a dummy ground. Accordingly, operation S101 may correspond to the structure where a dummy ground is connected to only the primary antenna among the primary antenna and the secondary antenna (see structure (b) of FIG. 4).

In operation S102, it is determined whether wireless communication between the mobile terminal and the base station has been started. If wireless communication between the mobile terminal and the base station has been started, the base station checks quality of service (QoS) of the wireless communication to determine whether MIMO communication can be performed in operation S103. If the base station determines that no MIMO communication can be performed, in operation S104, the base station controls the mobile terminal to continue to maintain the state in which the switch of the dummy ground of the primary antenna is turned on and the switch of the dummy ground of the secondary antenna is turned off, so as to operate only the primary antenna. If the base station determines that MIMO communication can be performed, in operation S105, the base station controls the mobile terminal to turn on both the switches of the dummy grounds of the primary antenna and the secondary antenna. In operation S106, the base station checks to determine whether the wireless communication connection has been terminated. If the wireless communication is maintained and not terminated, the method reverts back to operation S103 to have the base station check the QoS of the wireless communication to determine whether MIMO communication can be performed in order to determine whether to use the MIMO antenna. If the wireless communication is determined to have terminated in operation S106, the method terminates. More specifically, the base station may check to determine whether the wireless communication with the mobile terminal is maintained, and terminates the wireless communication if the wireless communication is no longer maintained.

The method of FIG. 17 relates to a MIMO antenna, however, aspects of the invention are not limited thereto, such that the method also may be applied to a Diversity antenna, a MISO antenna, a SISO antenna, and the like. Further, the method may apply to antennas in which antennas can be turned on/off selectively according to gain differences, resonance frequency differences, and the like of at least one of the primary antenna and the secondary antenna.

Therefore, according to exemplary embodiments of the present invention, the terminal with the plurality of antennas may improve communication efficiency in a multi-antenna environment by disposing dummy grounds to be connected to a main ground within a reference proximity to the individual antennas, to adjust the radiating pattern and phase of one or more antennas and reduce interference between the antennas.

Also, it may be possible to reduce distances between the antennas while maintaining the communication quality of a general multi-antenna, which may contribute to a significant reduction in size of a terminal.

Furthermore, by disposing a shared ground within a reference proximity to a side or an end of each antenna, instead of providing a plurality of grounds in correspondence to a plurality of antennas to change radiating polarization directions, it may be possible to reduce an ECC in a multi-antenna environment at a low frequency band, as well as at a high frequency band.

In addition, when no MIMO antenna system can be used due to a change in a wireless environment, one of a main antenna and a sub antenna may be selectively used by selectively connecting/disconnecting dummy grounds to/from a main ground, thereby increasing the efficiency of the selected antenna. Accordingly, the terminal may perform data transmission/reception with enhanced communication quality in a given communication environment.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a main ground comprising a first portion and a second portion;
a primary antenna connected to the first portion of the main ground;
a secondary antenna connected to the second portion of the main ground; and
a first dummy ground disposed within a reference proximity to at least one of the primary antenna and the secondary antenna.

2. The terminal of claim 1, wherein the primary antenna and the secondary antenna are separated by a reference distance.

3. The terminal of claim 1, wherein the first dummy ground is disposed within a reference proximity of at least one of the primary antenna and the secondary antenna.

4. The terminal of claim 1, wherein the first portion is an end portion that extends in a direction perpendicular to a plane in which the main ground extends, and the second portion is an end portion that extends in a direction parallel to a plane in which the main ground extends.

5. The terminal of claim 1, wherein the first portion is an upper end portion that extends in a direction perpendicular to a plane in which the main ground extends, and the second portion is to a lower end portion that extends in a direction perpendicular to the plane in which the main ground extends.

6. The terminal of claim 1, wherein the first portion is a lower end portion that extends in a direction perpendicular to a plane in which the main ground extends, and the second portion is to an upper end portion that extends in a direction perpendicular to the plane in which the main ground extends.

7. The terminal of claim 1, wherein a gain of the primary antenna or the secondary antenna is changeable according to the operation of the first dummy ground.

8. The terminal of claim 1, wherein a phase of a radiation signal of at least one of the primary antenna and the secondary antenna is changed by the first dummy ground.

9. The terminal of claim 1, wherein an Envelope Correlation Coefficient (ECC) between the primary antenna and the secondary antenna is changed by the first dummy ground.

10. The terminal of claim 1, wherein the main ground is grounded by the dummy ground.

11. The terminal of claim 1, wherein the primary antenna extends in a direction perpendicular to a plane in which the main ground extends and the secondary antenna extends parallel to the plane in which the main ground extends.

12. The terminal of claim 1, wherein the primary antenna and the secondary antenna extend in a direction perpendicular to a plane in which the main ground extends.

13. The terminal of claim 1, further comprising:
a second dummy ground,
wherein the first dummy ground is disposed within a reference proximity to the primary antenna and the second dummy ground is disposed within a reference proximity to the secondary antenna.

14. The terminal of claim 13, wherein at least one of the first dummy ground and the second dummy ground is perpendicular to the main ground.

15. The terminal of claim 13, wherein at least one of the first dummy ground and the second dummy ground comprises a switching device to control a connection to the main ground.

16. The terminal of claim 15, wherein the switching device of the first dummy ground is turned on by default, and the switching device of the second dummy ground is turned on if the terminal determines that at least one of a Multi-Input Multi-Output (MIMO) communication, a Diversity communication, and a Single-Input Single-Output (SISO) communication can be performed.

17. The terminal of claim 13, wherein the first dummy ground and the second dummy ground are disposed on the main ground with respect to a direction in which the main ground extends and are disposed at diagonal corners of the main ground.

18. The terminal of claim 13, wherein the first dummy ground is larger than the second dummy ground.

19. The terminal of claim 1, wherein an ECC of the terminal is affected by a size of the first dummy ground.

20. A method for controlling dummy grounds in a terminal, comprising:
turning on a switch of a first dummy ground connected to a primary antenna;
determining whether a reference type communication can be performed; and
turning on a switch of a second dummy ground connected to a secondary antenna.

21. The method of claim 20, further comprising:
changing a gain of the primary antenna or the secondary antenna according to the operation of the first ground.

22. The method of claim 20, further comprising:
changing a phase of a radiation signal of at least one of the primary antenna and the secondary antenna though the first dummy ground.

23. The method of claim 20, further comprising:
changing an Envelope Correlation Coefficient (ECC) between the primary antenna and the secondary antenna though the first dummy ground.

24. A terminal, comprising:
a main ground;
a primary antenna disposed on a first portion of the main ground;
a secondary antenna disposed on a second portion of the main ground;
a first dummy ground disposed within a reference proximity to the primary antenna; and
a secondary dummy ground disposed within a reference proximity to the secondary antenna.
